(19) United States
(12) Patent Application Publication
(10) Pub. No.: US 2006/0095484 A1
(43) Pub. Date: May 4, 2006

(54) Method and system for solving an optimization problem

(75) Inventors: Ashok Erramilli, Holmdel, NJ (US); Srinivas Netrakanti, Edmonton (CA)

Correspondence Address: William L. Botjer, PO Box 478, Center Moriches, NY, 11934, US

(73) Assignee: NETAPS INC., ABERDEEN, NJ (US)

(21) Appl. No.: 10/975,751

(22) Filed: Oct. 28, 2004

(51) Int. Cl. G06F 15/00

(52) U.S. Cl. 708/200

(57) ABSTRACT

This invention provides a method and system for solving an optimization problem under a set of constraints. A set of solutions is evaluated under the set of constraints. Initial violation metrics and states are generated, based on at least one constraint corresponding to the solutions violating the constraints. A set of candidate solutions is generated from the existing set of solutions by a set of operators. The set of candidate solutions is incrementally evaluated in a manner that is independent of the operators and the constraint. In case an evaluated solution is accepted, the violation metrics and states are updated on the basis of the accepted solution. However, if the evaluated solution is not accepted, a next candidate solution is incrementally evaluated. This process is repeated till all the candidate solutions are not checked for acceptance. Finally, the method terminates if a stopping criterion is met.

### BACKGROUND

This invention relates generally to the field of optimization. Specifically, it relates to a method and system based on a local search technique for solving optimization problems under a set of constraints.

Optimization problems are found in all industries. For example, one class of optimization problems relates to processes for planning, scheduling, and the manufacture of products on an assembly line. These processes are usually complex, and depend on a large number of factors such as variable capacities of equipment, multiple stages of manufacture, production of several kinds of products using a single resource, manpower or process limitations, and other factors specific to the corresponding industry, such as the life cycle of the product. In general, there can be a large number of rules or constraints that govern such processes. Therefore, it is important to plan, schedule or configure such processes in a way that they take place optimally within the constraints of the environment.

Conventional techniques for solving these problems include manual and automated optimization methods. Manual methods require human intervention. The degree of optimization obtained in manual methods largely depends on the skills and experience of the person involved, as well as the size of the optimization problem (indicated by the number of potential solutions and the number of constraints corresponding to the optimization problem). The methods are also time-consuming, cumbersome and can lead to problems, such as poor solution quality and human error. Manual methods become unfeasible as the size of the problem increases. Automated methods utilize a defined algorithm to solve the optimization problem. A general class of automated methods for optimization is based on the concept of local search (LS). This technique covers a range of combinatorial heuristics, such as simulated annealing, genetic algorithm, taboo search and evolutionary algorithms.

One such heuristic is provided in the reference titled “Facts, Conjectures and Improvements for Simulated Annealing”, authored by P. Salamon, P. Sibani and R. Frost and published by SIAM Monograph in the year 2002.

Another such heuristic is provided in the reference titled “Genetic Algorithms and Engineering Design”, authored by M. Gen and R. Chang, and published by John Wiley & Sons in the year 1997.

Yet another heuristic is provided in the reference titled “Modern Heuristic Techniques for Combinatorial Problems”, authored by Colin Reeves and published by Halsted Press in the year 1993.

The LS technique solves an optimization problem by making local moves in the space of solutions. The solution for an exemplary manufacturing-scheduling problem can be a mathematical representation of a production schedule, which is in effect the timetable according to which different items are manufactured. In all LS heuristics, an initial set of one or more solutions is generated by a convenient mechanism. Any convenient mechanism can be used because the initial set of solutions need not satisfy any constraints; they can therefore even be generated randomly. LS heuristics systematically refine the set of solutions by making small or local changes. This results in a new set of candidate solutions. The technique for generating these local changes varies according to the LS heuristic used. The set of candidate solutions is then evaluated to determine defects or violations of the existing constraints. Based on an acceptance criterion that varies according to the heuristic used, one or more of the candidate solutions are accepted. This process is repeated until the solutions do not improve appreciably, or a computational budget is exceeded. In practice, obtaining a high-quality solution requires a large number of moves, and the practical utility of the LS heuristic rests on the efficient evaluation of a large number of candidate solutions (of the order of 10⁶ to 10⁸) against numerous constraints.

Conventionally, solutions are evaluated in their entirety. This requires high-speed computers with large storage capacities. If the evaluation is carried out incrementally (i.e., only in the neighborhoods in which the solution has changed), the method is specific to a particular constraint and depends on the manner in which the local moves are generated. This requires extensive and ongoing software development or other product development. Therefore, it is evident that prolonged computational time and high expenses limit the practical use of LS based methods.

Accordingly, there is a need for developing techniques that speed up the computational process, while providing efficient solutions to practical optimization problems. Such techniques should be cost-effective. It should also be possible to implement them on workstations and PCs, with the process requiring minimal human intervention.

### SUMMARY

An object of the present invention is to provide a method and system for solving an optimization problem, given a set of constraints.

Another object of the invention is to provide a method and system for the incremental evaluation of a set of solutions to solve an optimization problem, given a set of constraints.

Yet another object of the invention is to provide a method and system for solving an optimization problem, wherein the evaluation of solutions is independent of the nature of the constraints.

Yet another object of the invention is to provide a method and system for solving an optimization problem, wherein the evaluation of the solutions is independent of the manner in which candidate solutions are generated.

The above-mentioned objectives are achieved through the following embodiments of the invention. In an embodiment of the invention, a method for solving an optimization problem under a set of constraints is provided. In this method, a set of solutions is evaluated against the constraints. This evaluation generates an initial set of violation metrics and a set of states that capture the information needed to perform incremental evaluation during the LS procedure. After this initial evaluation, a set of candidate solutions are generated from the set of solutions by a set of operators in a manner that is characteristic of the LS heuristic used. The effect of an operator on a solution is represented by a set of change points. Each candidate solution is then evaluated in the neighborhood of each change point by using information pertaining to the computed states. The output of this incremental evaluation is a set of new violation metrics, as well as the new states corresponding to the change points in the solution. The changes in the violation metrics for each constraint are then transformed into a change in a cost function. A candidate solution is accepted on the basis of the incremental evaluation and an acceptance criterion that is characteristic of the LS heuristic. This process is repeated for each of the candidate solutions. The process terminates if a stopping criterion is satisfied, for example, if the number of iterations exceeds a specific number of iterations, or if no further improvement is observed in the solutions for a number of iterations.

In yet another embodiment of the invention, a system for solving an optimization problem under a set of constraints is provided. The system includes a means for evaluating solutions for the optimization problem, generating violation metrics and states for a solution, and updating violation metrics and states. The system also includes a means for operating on a set of solutions to generate a candidate set of solutions, a means for accepting a solution of the optimization problem, and a means for comparing solutions and states.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 shows an exemplary computing system on which the method for solving an optimization problem is implemented, in accordance with an exemplary embodiment of the present invention;

FIG. 2 is a flowchart showing a method for solving an optimization problem, in accordance with an exemplary embodiment of the present invention;

FIG. 3 illustrates a system for solving an optimization problem, in accordance with an exemplary embodiment of the present invention;

FIG. 4 illustrates a mapping of the violation metric into the cost, in accordance with an exemplary embodiment of the invention; and

FIG. 5 illustrates a schematic circuit diagram for implementing a system that enables incremental evaluation, in accordance with an exemplary embodiment of the present invention.

### DESCRIPTION OF PREFERRED EMBODIMENTS

For purposes of clarity, the following terms used herein are defined below:

Solution: A solution is a mathematical representation of a function or process that is the desired result from the optimization problem. It may be represented by a list of elements, in which elements can themselves be other lists. The elements of the solution are indexed by a set of coordinates {i1, i2, . . . , iN}. For example, for a problem in which the solution is represented in two dimensions, an index list {2,3} refers to the third element of the second list in the solution. The Gantt chart representing assembly line schedule, is an example of this representation.

Constraint: A constraint is a rule that a solution should ideally satisfy. The rule may apply at a single point in the solution, or it may govern the characteristics of a set of points. Violations of a constraint directly or indirectly result in an incurred cost or penalty, and are quantified by a violation metric.

Evaluator: An evaluator checks a single solution against a constraint or set of constraints. An output of the evaluator is a set of violation metrics. The violation metrics are transformed into a cost function or cost, which is the objective function of the optimization.

Objective function: An objective function is defined as a function that is optimized. For example, in the exemplary manufacturing scenario, the solution is the schedule for the assembly line, whereas the objective function is a penalty or cost that has to be minimized.

State: A state is defined at each element of the solution for a given constraint. The state at an element encodes the impact of all other elements on the element for the constraint.

Operator: An operator generates a move in the space of solutions, thereby generating a candidate solution from the existing set of solutions.

Move: A move generated by the operator is represented by a list of change points. In the exemplary embodiment, each change point is a list including two elements. The first element is a range of coordinates, and the second element is a list of changes corresponding to this coordinate range. In an exemplary move, the elements of the solution indexed by the first element of the change point may be replaced by the second element of the change point.

The present invention provides a method, system and computer program product for solving an optimization problem under a set of constraints. An exemplary optimization problem can be the traveling salesman problem (TSP). The solution to this problem involves finding an optimum sequence for visiting a set of cities to minimize a cost function, such as the total travel distance or time. The cost of travel between every pair of cities is provided. Another exemplary optimization problem is sequencing a set of production tasks on an assembly line in a manufacturing environment. Each task can have an associated deadline. Additionally, there may be a large number of associated constraints, such as succession or precedence of tasks, maximum or minimum number of a given type of task that can be sequenced within a time period or in a run, and the spacing between the tasks. The objective of the optimization is to schedule each task so that associated deadlines and all associated constraints are met. The present invention is suitable for solving various optimization problems in the areas of distribution planning, vehicle routing, multi-level scheduling and other optimization problems not limited to these examples.

To aid understanding, the defined terms are further illustrated by using the following example: In the traveling salesman problem (TSP), a solution is represented by a list of cities corresponding to the order in which the cities are to be visited. The state at a given city, for a constraint that governs travel distance, can be the cumulative distance traveled to reach that city. An example of an operator that generates local moves is one in which a pair of cities in the list is swapped. If two cities in the list, Cᵢ and Cⱼ, are swapped, the resulting move can be represented by the following list: {{{i, i}, {Cⱼ}}, {{j, j} {Cᵢ}}}. It is to be noted that when a solution undergoes a change, the corresponding set of states are also changed.

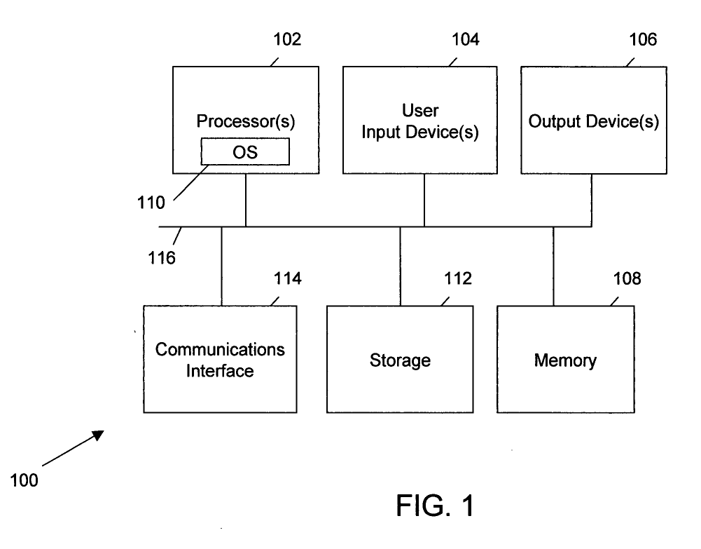

The method of the present invention is implemented on a computing system that also includes a user input device and a user output device. FIG. 1 shows an exemplary computing system 100 on which the method for solving an optimization problem is implemented, in accordance with an exemplary embodiment of the present invention. Computing system 100 includes a processor 102 for carrying out the optimization. Processor 102 may be one or more general-purpose processors or special-purpose processors, such as, Pentium®, Centrino®, Power PC®, and digital signal processors (DSP). Computing system 100 also includes one or more user input devices 104, such as a mouse, a keyboard, and other user input devices. Computing system 100 also includes one or more output devices 106, such as a suitable display, actuators, electronic devices, and other output devices, depending on the processing job. A memory 108, such as read only memory, random access memory or cache memory provides memory required to store computed values generated during the process of solving the optimization problem. Memory 108 may also include, but is not limited to, one or more application programs, mobile codes, and data for implementing the required applications. Processor 102 may include an operating system (OS) 110. The type of OS 110 may depend on functions of computing system 100 or a particular device or feature of computing system 100. Some exemplary OS 110 may be Windows, WindowsCE, Mac OS X, Linux, Unix, Palm OS variants, a proprietary OS, and other OS 110. A storage 112, such as a hard disk, floppy disk, compact disk, digital versatile disk (DVD), partially or fully hardened removable media, and other removable disks, may store the required data and other applications.

One or more suitable communication interfaces 114 provide either direct communication between two devices or communication via suitable private or public networks for the exchange of data and other information relating to the optimization problem. A few exemplary communication interfaces 114 may be a modem, a DSL, infrared transceiver, a radio frequency (RF) transceiver, or other suitable transceivers. The components of the system described above are connected through communication channels 116, such as a bus. Communication channels 116 may also include but are not limited to devices for parallel processing or cluster implementation.

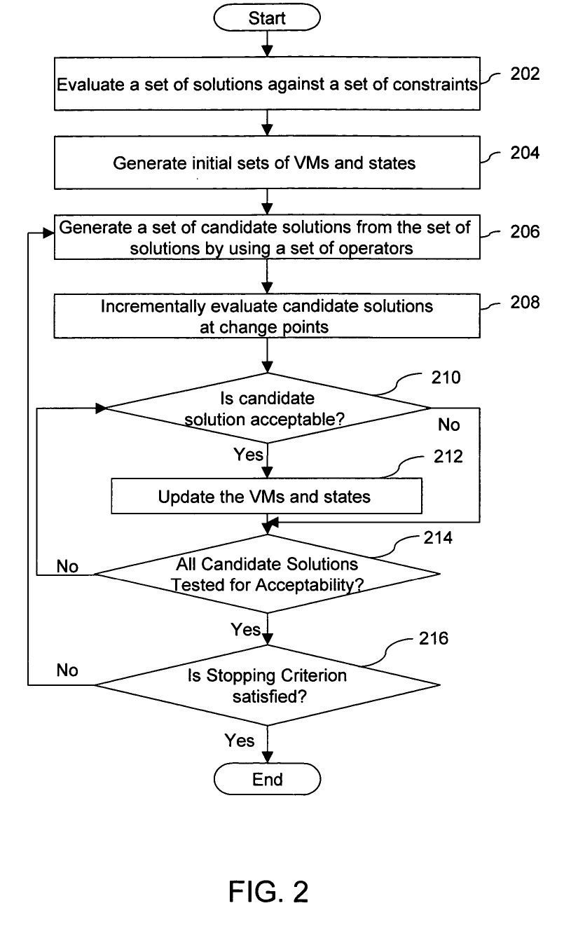

FIG. 2 is a flowchart showing a method for solving an optimization problem, in accordance with an exemplary embodiment of the present invention. The method involves solving the optimization problem under a set of constraints based on a local search (LS) heuristic. Examples of LS heuristics include simulated annealing, genetic algorithm, taboo search and evolutionary algorithms. A set of solutions for the optimization problem is evaluated at step 202 under the set of constraints. Initial sets of violation metrics and states are generated at step 204, based on the evaluation of the set of solutions. A set of candidate solutions, derived from the set of solutions, is then generated at step 206 by using a set of operators that is characteristic of the LS heuristic used.

In an embodiment of the present invention, each operator is essentially a mathematical function that modifies a solution from amongst the set of solutions by generating a set of change points. Definitions of the operator and the associated change points have been provided earlier. A candidate solution is generated by applying the mathematical function to this solution, and the result is described by a set of change points. Correspondingly, a new set of states is generated from the state, based on the change points. The candidate solution is incrementally evaluated at step 208. Incremental evaluation is performed locally in the neighborhood of a particular change point. It is to be noted that the evaluation is completely determined by (i) the solution point and (ii) the state at that point. Thus, incremental evaluation proceeds as long as the candidate solution is logically unequal with the solution, or the state and the new state are unequal. The process of incremental evaluation is described in detail later in the description. At step 210, it is checked whether the evaluated candidate solution is acceptable as a solution to the optimization problem. This check is based on an acceptance criterion.

The acceptance criterion depends on the LS heuristic. For example, in Simulated Annealing, the candidate solution is accepted if it has a lower cost; it may also be accepted probabilistically, even if it has a higher cost. In Genetic Algorithms, a set of solutions is selected from the set of initial and candidate solutions, based on a rank ordering of the cost or fitness function. Subsequently, at step 212, the violation metrics and states are updated, if a solution is accepted.

Step 214 checks if all candidate solutions have been tested, and step 216 checks if a stopping criterion has been satisfied. Otherwise, a new set of candidate solutions is again generated for evaluation, till the stopping criterion is satisfied. In an embodiment of the present invention, the stopping criterion can be the completion of a predefined number of iterations, which depends on factors such as the complexity of the optimization problem and the time available for solving the optimization problem. Another stopping criterion could be a less than minimum improvement in overall solution quality over a number of iterations. In this manner, for each solution that violates the constraints, a candidate solution is generated and evaluated at various change points, to generate solutions that improve over a number of iterations.

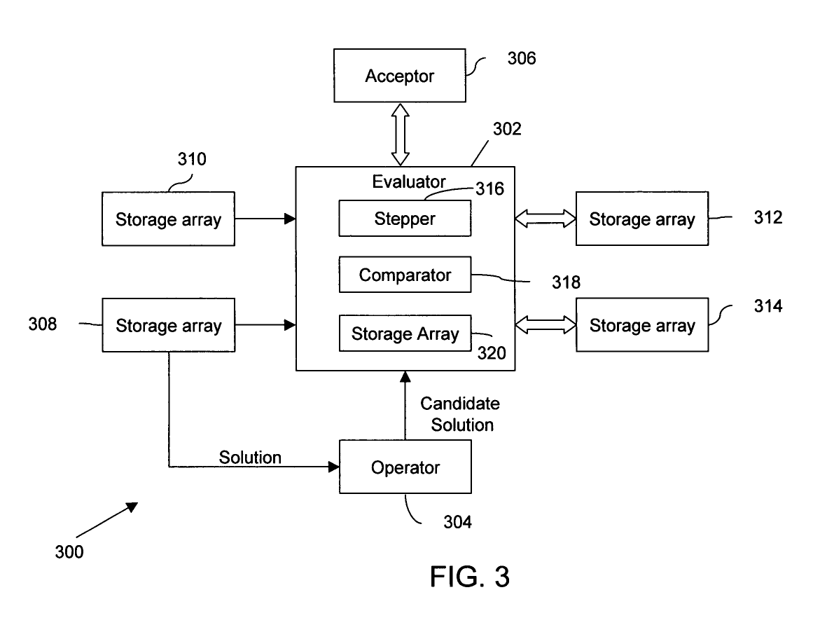

FIG. 3 illustrates a system 300 for solving an optimization problem, in accordance with an exemplary embodiment of the present invention. System 300 comprises an evaluator 302, an operator 304, and an acceptor 306. In various embodiments of the invention, system 300 further includes storage arrays 308, 310, 312 and 314. Storage arrays 308 and 310 store a solution and the corresponding state, respectively. Storage arrays 312 and 314 store a new state and violation metrics, respectively. Evaluator 302 includes a stepper 316 and a comparator 318. In an embodiment of the invention, evaluator 302 also includes a storage array 320. Stepper 316 performs a step-by-step evaluation of a candidate solution against a constraint. Comparator 318 can compare two parameters, such as two solution points or two states, for logical equality. Storage array 320 can also store the solution, the candidate solution, violation metrics, and various states generated during the evaluation.

According to the method described above, storage arrays 308 and 310 input a solution and the corresponding states into evaluator 302. Evaluator 302 generates an initial set of violation metrics and new states, based on the evaluation of the solution. Storage array 308 also inputs the solution into operator 304. Operator 304 operates on the solution, to generate a candidate solution. The candidate solution is evaluated by evaluator 302 at the new state. If acceptor 306 accepts the candidate solution, the stored violation metrics and the states are updated.

Each of the system elements, for example stepper 316 and comparator 318, may be implemented by using logical circuits, or as software modules. Each of storage arrays 308, 310, 312, 314 and 320 can be memory devices such as Random Access Memory, and Read only Memory.

Evaluator 302 evaluates solutions of the optimization problem, generates corresponding violation metrics, and also updates the violation metrics and states. Evaluator 302 stores information corresponding to the states. Evaluator 302 further evaluates a set of solutions under a given constraint. In an embodiment of the invention, any constraint that may be implemented as a software code is supported. The set of solutions can be generated by random statistical techniques or other techniques known in the art. For example, the solution from amongst the set of solutions can be generated for a reduced constraint set by a simpler greedy heuristic or the basis of patterns or prior solutions. Evaluator 302 also includes a function that maps between the coordinates of a current solution and a candidate solution.

In an embodiment of the present invention, the evaluation may occur in two phases. In a first phase of evaluation, evaluator 302 generates an initial set of violation metrics (VM) and states for the given constraint corresponding to each solution in the initial set. In this phase, evaluator 302 begins evaluating the solution at a null state. The null state corresponds to a state at which all the variables have zero magnitude. Stepper 316 has built in rules to account for the null state. On completion of the evaluation, evaluator 302 populates the states. This evaluation is performed by using a function referred to as ‘EVAL’ function.

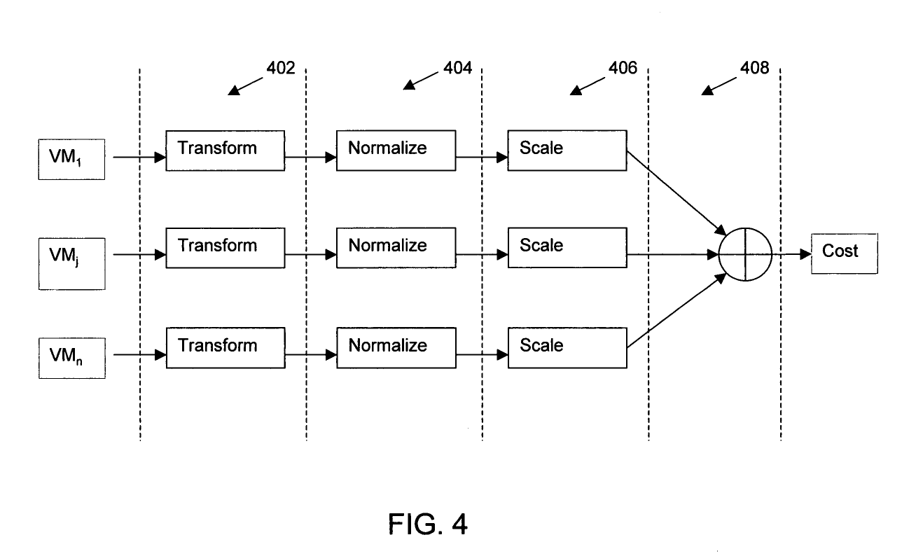

The VM is a measure of violations of the constraint, i.e., to what extent the solution conforms to the constraint. Violations can have variable magnitude, and different violations may affect the solution costs in different ways. In state machine terminology, the VMs are the output of stepper 316. For example, there may be a constraint in the TSP that a tour should not have more than three cities in a row in the same province. In this case, the VMs are vectors wherein each vector may have an element corresponding to every change of province in the tour; and the magnitude of the vector corresponds to the run length of cities in that province. This may impact costs in different ways. In some cases, violation of the constraint (i.e., all runs in a province with more than three cities) may be equally unfavorable, irrespective of the run length (i.e., whether the run length is 4 or 40). In other cases, the cost may be a function of the violation and may scale as a quadratic or higher power of the violation. Thus, the VMs correspond to the violations, and a separate mathematical function transforms, normalizes and scales them into the cost (see FIG. 4). The VM in this example is a vector, but generally it can be a list with the same structure as the solution.

FIG. 4 illustrates the mapping of the VMs into the cost. The mapping of the VMs {VM₁ . . . , VMⱼ, . . . , VMₙ} into the cost comprises four steps. At step 402, transformation of the VMs takes place, based on a defined function. The purpose of this transformation is to reflect the impact of the violation. At step 404, the transformed VMs are normalized, to remove the effect of intrinsic variations in the magnitude of the VMs that can occur in different constraints. At step 406, the normalized VMs are scaled. The scaling reflects the priorities that may be assigned to each constraint. Thus, a high priority constraint has a higher scale factor than a lower priority constraint. At step 408, the scaled VMs are summed to generate the cost associated with the violations. The cost, as computed in FIG. 4, is then evaluated against an acceptance criterion in a manner that is specific to the LS based algorithms used.

To summarize, the cost is a function of the violations of the constraint, the rules associated with the violations, and other parameters that can be varied, to achieve a range of behaviors and impacts. The term ‘cost’ may be referred to as a penalty function or a fitness function, depending on the LS algorithm used for implementing the present invention.

After the first phase of evaluation, an initial set of VMs and states corresponding to the set of solutions are generated. The solutions are then operated upon, by using an operator, to bring about local changes in the solution. In an optimization problem, the purpose of operating on a solution is to modify it. In an exemplary embodiment of the present invention, the incremental evaluation proceeds independently of the operation. This allows the embodiment to have any number of operators, each of which may be suited to a specific application.

In one embodiment of the present invention, there may be several operations performed by an operator on the solution. These include, but are not limited to, ‘swap’, ‘insert’, ‘shift’ and ‘delete’ operations. In an exemplary embodiment of the present invention, the coordinates of the solution may be shifted during an operation. For example, a swap operation on the solution may not change the coordinates of the elements or the part of the elements that are not involved in the operation. However, a ‘delete’ operation on a part of the solution and an ‘insert’ operation may shift the coordinates of the elements of the solution. The effect of an operation can persist or spill over into other regions of the solution. For example, in the TSP, if the state corresponds to the list of partial distances, then any swap involving two cities changes the partial distances of all cities between the swapped cities.

After the operation, at least one candidate solution, derived from the solution, is generated. The candidate solution undergoes a second phase of evaluation. During this phase, the candidate solution is evaluated under the set of constraints for a change point corresponding to the operator at the new state. This process may be referred to as incremental evaluation. Incremental evaluation may be implemented by using a ‘INC_EVAL’ function. Incremental evaluation occurs in steps. Each step is indexed by a set of integers. At each step, the candidate solution is evaluated for a change. This change corresponds to a change point corresponding to the operator acting on the solution, which contributed to the generation of the candidate solution. Evaluator 302 evaluates the candidate solution at the new state, and computes a corresponding VM and a next state. This VM is referred to as incremental VM (INC_VM).

After the second phase of evaluation, the candidate solution may be accepted. In one embodiment of the present invention, the candidate solution is accepted on the basis of a logic that is external to evaluator 302. This logic may be implemented in the form of an ‘ACCEPT’ function. Once the candidate solution is accepted, the incremental VM and the new state are updated, based on the accepted solution. The incremental VM that has been updated is referred to as the updated VM. In case the candidate solution is not accepted, a next candidate solution is evaluated. This process is repeated till all the candidate solutions in the set of candidate solutions are evaluated.

To summarize, evaluator 302 comprises the functions ‘EVAL’, ‘INC_EVAL’ and ‘ACCEPT’. Given a solution and a corresponding state as inputs, these functions generate the outputs VM, INC_VM and a new state in the process of evaluation.

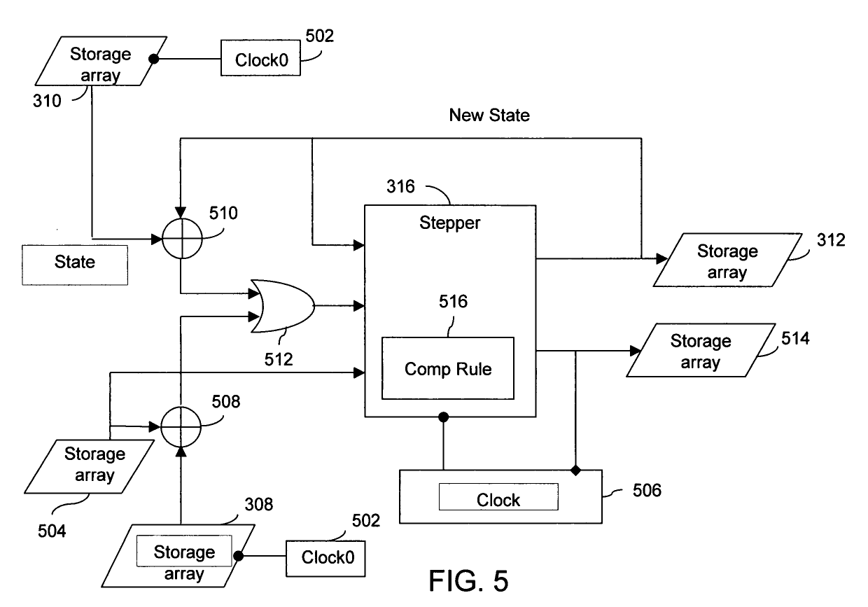

FIG. 5 illustrates a schematic circuit diagram for implementing a system that enables incremental evaluation, in accordance with an exemplary embodiment of the present invention. In this example, the solution is a vector, and the coordinates can be interpreted as discrete clock ticks. As described earlier, storage array 308 stores the solution, and storage array 310 stores the state of the solution. A Clock0 502 generates the coordinates of the solution stored in storage array 308. A storage array 504 stores the candidate solution, while storage array 312 stores the new state corresponding to the candidate solution. A Clock 506 generates the coordinates of the candidate solution stored in storage array 504. These two clocks differ by a series of ‘phase shifts’ corresponding to the fact that the effect of an operation may be to shift the coordinates. In an exemplary embodiment of the present invention, Clock 506 can be implemented by any standard clock-generating circuit, and is suitably shifted to derive Clock0 502. In another embodiment of the invention, Clock0 502 and Clock 506 can be implemented by using software codes.

The candidate solution stored in storage array 504 and the stored solution in storage array 308 are inputs to an inequality (IEQ) component 508. The new state stored in storage array 312 and the state stored in storage array 310 are inputs to an IEQ component 510. Each of IEQ components 508 or 510 checks for logical equality between its two inputs, and outputs a ‘1’ if the inputs are unequal. The outputs of IEQ components 508 or 510 are inputs to an OR logic block 512. In case the output of OR logic block 512 is ‘1’ (i.e., either the candidate solution is logically unequal with the solution, or the state and the new state are logically unequal), stepper 316 takes the candidate solution stored in storage array 504 as an input. Stepper 316 checks for violation of at least one constraint. Stepper 316 generates an incremental VM (INC_VM) on evaluating the candidate solution. The generated INC_VM is stored in a storage array 514. After each incremental evaluation, the new state is also updated. In case the candidate solution is accepted after the incremental evaluation, the new state is fed back to stepper 316 and IEQ component 510. This process may be repeated, depending on the output of IEQ component 510. In an embodiment of the present invention, IEQ components 508 and 510 and OR logic block 512 are included in comparator 318 of FIG. 3. This comparison is achieved by comparing the candidate solution and the new state corresponding to INC_VM, with the solution and state corresponding to the initial VM. There may also be other means of comparing VMs.

A component ‘Comp Rule’ 516 of stepper 316 encodes the logic specific to a rule for determining whether a violation has occurred at a point in the candidate solution or the solution, and, the extent of the violation, if it has occurred. In other words, Comp Rule 516 encodes the logic by which a VM and state are generated. Stepper 316, and in particular ‘Comp Rule’ 516, can be implemented by using a programmable logic array (PLA).

The present invention is suitable for evaluating a large number of candidate solutions (of the order of 10⁶ to 10⁸) against constraints in a computationally cost-effective manner. In an embodiment of the present invention, evaluator 302 stores state information that allows it to evaluate the set of solutions or candidate solutions from any point within themselves. Each evaluator incrementally evaluates the candidate solution at only those points that differ from existing solutions. Evaluator 302 can rapidly compute these differences by considering the neighborhoods of only those parts of the solution that differ from the existing solutions.

Each evaluator has the same structure, regardless of the constraint and the manner in which the candidate solution is derived from an existing solution. Each evaluator incorporates state information, which at every point in the solution summarizes the effect of the rest of the solution at that point. In this way, evaluator 302 can process only those parts of the solution that differ, without evaluating the entire solution. It is to be noted that the ‘Comp Rule’ 516 is the only component of the arrangement that varies according to the rules associated with violations of constraints; all other components are invariant for all the rules. Further, all components of the evaluator are invariant for all operators. Therefore, in an embodiment of the invention, the addition of new constraints or operators requires minimal additional logic to implement the present invention.

The present invention has the advantage that the time required to solve the optimization problem may be reduced by two to three orders of magnitude, compared to a conventional method. The present invention also supports any mechanism that generates candidate solutions from existing solutions.

The present invention may be implemented in hardware, as described by using FIG. 3 and FIG. 5. It may be implemented in an integrated circuit or part of an integrated circuit, such as an application specific integrated circuit, field programmable gate arrays, programmable logic arrays, and full-custom integrated circuits.

The present invention may also be implemented as software. Specifically, the present invention may be implemented in Java by using the simulated annealing algorithm in an exemplary embodiment of the invention. Since, evaluators share a common structure and differ only in terms of a computational rule that reflects the specific constraint, each evaluator differs in a single method in an object-oriented implementation of the present invention. Various programming languages or other tools may also be utilized, such as those compatible with C variants (for example, C++, C#), or other programming languages, in accordance with the requirements of a particular application.

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer comprises a microprocessor. The microprocessor is connected to a communication bus. The computer also includes a memory. The memory may include Random Access Memory (RAM) and Read Only Memory (ROM). The computer system further comprises a storage device. It can be a hard disk drive or a removable storage device such as a floppy disk drive, optical disk drive, etc. A storage device can also be other similar means for loading computer programs, or other instructions, into the computer system.

The computer system executes a set of instructions that are stored in one or more storage elements, in order to process input data. The storage elements may also hold data or other information, as desired. They may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms, such as system software or application software. Further, the software might be in the form of a collection of separate programs, a program module with a larger program, or a portion of a program module. The software might also include modular programming in the form of object-oriented programming. The processing of input data by the processing machine may be in response to user commands, to results of previous processing, or to a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method for solving an optimization problem under a set of constraints, the method comprising:
a. evaluating a set of solutions for the optimization problem under the set of constraints;
b. generating initial sets of violation metrics and states based on the set of constraints corresponding to the set of solutions that violate at least one constraint during the evaluation;
c. generating a set of candidate solutions derived from the set of solutions by using a set of operators, each operator characterized by a set of change points;
d. evaluating the set of candidate solutions at the change points;
e. testing an evaluated candidate solution for acceptance based on an acceptance criterion;
f. if the tested candidate solution is accepted, updating the violation metrics and the states based on the accepted candidate solution;
g. repeating steps e-f till all the evaluated candidate solutions are tested for acceptance; and
h. repeating steps c-g till a stopping criterion is satisfied.

2. The method according to claim 1, wherein evaluating the set of solutions for the optimization problem comprises evaluating the set of solutions by using null states.

3. The method according to claim 1, wherein each violation metric is mapped to a cost, the mapping comprising:
a. transforming each violation metric based on a defined function;
b. normalizing each of the transformed violation metric;
c. scaling each of the normalized violation metric based on priority associated with each constraint; and
d. summing the scaled violation metrics to generate the cost associated with the violations of the constraints.

4. The method according to claim 1, wherein the operations performed by the set of operators include at least one of swap, insert, shift and delete operations on a solution.

5. The method according to claim 1, wherein evaluating the set of candidate solutions comprise incrementally evaluating a candidate solution from amongst the set of candidate solutions at each change point associated with the corresponding operator.

6. The method according to claim 1, wherein the candidate solution is incrementally evaluated till the candidate solution is logically equal to the corresponding solution and the states corresponding to the candidate solution and the corresponding solution are logically equal.

7. The method according to claim 1, wherein the stopping criterion is met when:
a. a predetermined number of iterations are completed; or
b. the degree of improvement in the set of candidate solutions is less than a predetermined degree of improvement over a predetermined number of iterations.

8. The method according to claim 7, wherein the completion of the predetermined number of iterations is based on:
a. the complexity of the optimization problem; and
b. the time available for solving the optimization problem.

9. A system for solving an optimization problem under a set of constraints, the system comprising:
a. means for evaluating a set of solutions for the optimization problem under the set of constraints;
b. means for generating initial sets of violation metrics and states based on the set of constraints corresponding to the set of solutions that violate at least one constraint during the evaluation;
c. means for operating on the set of solutions to generate a set of candidate solutions;
d. means for comparing solutions and states;
e. means for accepting the evaluated solution based on an acceptance criterion; and
f. means for updating the violation metrics based on the accepted solution.

10. A system for solving an optimization problem under a set of constraints, the system comprising:
a. an evaluator for evaluating solutions of the optimization problem, generating violation metrics for the solutions, and updating violation metrics and states;
b. an operator for operating on a solution to generate a candidate solution; and
c. an acceptor for accepting a solution of the optimization problem.

11. The system according to claim 10, wherein the evaluator comprises a stepper for generating and updating a violation metric.

12. The system according to claim 11, wherein the stepper determines the violation based on at least one rule for determining a violation of at least one constraint.

13. The system according to claim 10, wherein the evaluator comprises a comparator for comparing a pair of solutions and a pair of states.

14. The system according to claim 10, wherein the evaluator comprises a storage array for storing information corresponding to a state.

15. The system according to claim 10, wherein the evaluator comprises a storage array for storing the generated solution.

16. A computer program product for solving an optimization problem under a set of constraints, the computer program product comprising a computer readable medium comprising:
a. program instruction means for evaluating a set of solutions for the optimization problem under the set of constraints;
b. program instruction means for generating initial sets of violation metrics and states based on the set of constraints corresponding to the set of solutions that violate at least one constraint during the evaluation;
c. program instruction means for generating a set of candidate solutions derived from the set of solutions by using a set of operators, each operator characterized by a set of change points;
d. program instruction means for evaluating the set of candidate solutions at the generated change points;
e. program instruction means for testing an evaluated candidate solution for acceptance based on an acceptance criterion;
f. program instruction means for updating the violation metrics and the states based on the accepted solution; and
g. program instruction means for checking for satisfying a stopping criterion.
